(19) United States
(12) Patent Application Publication
(10) Pub. No.: US 2018/0196976 A1
(43) Pub. Date: Jul. 12, 2018

(54) SMALL DIFFERENTIAL ELECTRIC FIELD ACTIVATED UHF RFID DEVICE

(71) Applicant: AVERY DENNISON RETAIL INFORMATION SERVICES, LLC, Mentor, OH (US)

(72) Inventor: Ian J. FORSTER, Chelmsford (GB)

(21) Appl. No.: 15/868,503

(22) Filed: Jan. 11, 2018

Related U.S. Application Data
(60) Provisional application No. 62/444,823, filed on Jan. 11, 2017.

(51) Int. Cl. G06K 7/10; G06K 19/18

(52) U.S. Cl. CPC G06K 7/10366; G06K 19/18; G06K 7/10158

(57) ABSTRACT

A small differential-electric-field-activated UHF RFID device. Such a device may be small and easy to manufacture, improving the viability of incorporating RFID technology into articles like tickets, cards, and tokens. Such a device may also be small and inexpensive enough to allow for redundant RFID chips to be placed on an article, improving the survivability of an RFID-enabled article. Such a device may also reduce the amount of metal or plastic that is used in order to create an article such as a smart ticket or card, improving recyclability.

### CROSS REFERENCE TO RELATED APPLICATION(S)

The present application claims priority to and the benefit of U.S. provisional patent application No. 62/444,823 filed on Jan. 11, 2017, which is incorporated herein by reference in its entirety.

### BACKGROUND

“Smart labels,” also called “smart tags,” are print-coded labels which incorporate extremely flat configured transponders as an inlay inside the label. These transponders typically include a chip, an antenna, and bonding wires.

In many processes, such as in logistics and transportation, “smart labels” or “intelligent labels” have been replacing more conventional optical barcodes, as well as 2D barcodes, QR codes and the like, as the key means by which items can be identified and tracked. The automation of such optical coding is limited in appropriate distance for reading success, and typically requires manual manipulation in order to bring the code into the vision range of a scanner (or, alternatively, requires the use of a scanner gate that scans the entire surface of a coded object). Smart labels, however, can be read from a distance, without having to be in the line of sight of the scanner and thus facilitate automation.

However, smart labels do have certain downsides. For example, smart labels are somewhat more susceptible to physical damage than optical barcodes. Smart labels are also somewhat more expensive to use than optical barcodes. While optical barcode labels can be printed using conventional label printers or even standard consumer-grade inkjet printers, smart labels must be printed using more specialized printers, and have a somewhat higher failure rate from printing (often around 5%). Lastly, smart labels can be somewhat larger and more obtrusive than optical barcode labels, limiting their usefulness in some applications. For example, “RFID Tickets” typically have large embedded antennae spanning a large portion of the ticket, meaning that a user may risk damaging the ticket and making it unusable by folding it.

### SUMMARY

According to an exemplary embodiment, a small differential-electric-field-activated UHF RFID device may be disclosed. Such a device may be small and easy to manufacture, improving the viability of incorporating RFID technology into articles like tickets, cards, and tokens. Such a device may also be small and inexpensive enough to allow for redundant RFID chips to be placed on an article, improving the survivability of an RFID-enabled article. Such a device may also reduce the amount of metal or plastic that is used in order to create an article such as a smart ticket or card, improving recyclability.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a coupler and strap pairing.

FIG. 2 is an exemplary embodiment of a coupler and strap pairing.

FIG. 3 is an exemplary diagram illustrating coupling by capacitance.

FIG. 4 is an exemplary embodiment of a side view of a coupler.

FIG. 5 is an exemplary embodiment of a side view of a coupler.

FIG. 6 is an exemplary embodiment of an RFID device.

FIG. 7 is an exemplary embodiment of an RFID device that has been added to a ticket.

FIG. 8 is an exemplary diagram illustrating the use of a ticket equipped with an RFID device.

FIG. 9 is an exemplary diagram illustrating the use of an RFID device with a surface that provides coupling regardless of relative, X, Y and theta orientation.

FIG. 10 is an exemplary embodiment of an RFID device as coupled to a far-field antenna.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, some embodiments may be described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring generally to the Figures, various exemplary implementations of a small differential-electric-field-activated UHF RFID device (“RFID device”) may be disclosed. In some embodiments, such an RFID device may also be referred to as a “interposer” or comprising a “RFID strap.” In one embodiment presently contemplated, a form of differential electric field device utilized a dipole antenna, with a total length of half wave at the operating frequency, approximately 152.5 mm at FCC band. In one example of the present invention, a device is provided where the total length is less than 1/30th of a wavelength at the operating band, approximately 10.2 mm. It is important to note, however, that the present application is not limited to any particular size.

According to an exemplary embodiment, an RFID device may be designed to be small and easy to manufacture in high volume. The low cost and small size may each improve the viability of incorporating the device into smaller, thinner, and/or lower-cost articles such as tickets, cards (such as payment cards or identification cards) and tokens, allowing such articles to be equipped with RFID technology under circumstances that were not possible or practical before. In some exemplary embodiments, an article may even be equipped with multiple redundant RFID devices in order to improve reliability, allowing the article to still be read by an RFID reader in the event that one or more of the RFID devices breaks or is rendered unusable.

According to an exemplary embodiment, the small size of the RFID device may serve to decrease the amount of metal and plastic that is used to manufacture the RFID device. This may have advantages for manufacturing, but may also serve to make RFID-equipped articles more recyclable.

According to an exemplary embodiment, an RFID device may have approximate measurements of 5 mm by 10 mm. According to another exemplary embodiment, an RFID device may be larger than these dimensions in order to improve readability, may be smaller than these dimensions in some applications (such as where it may be practical to have a higher-precision reader) or may have any other measurements, as desired. According to an exemplary embodiment, the tabs of the RFID device may be a small fraction of the wavelength used at the operating frequency.

In order to read the RFID device, according to some exemplary embodiments, the RFID device may be put in connection with a coupler. In an exemplary embodiment, the coupler may be or may include, for example, two plates, between which may exist a differential electric field designed to operate the RFID device.

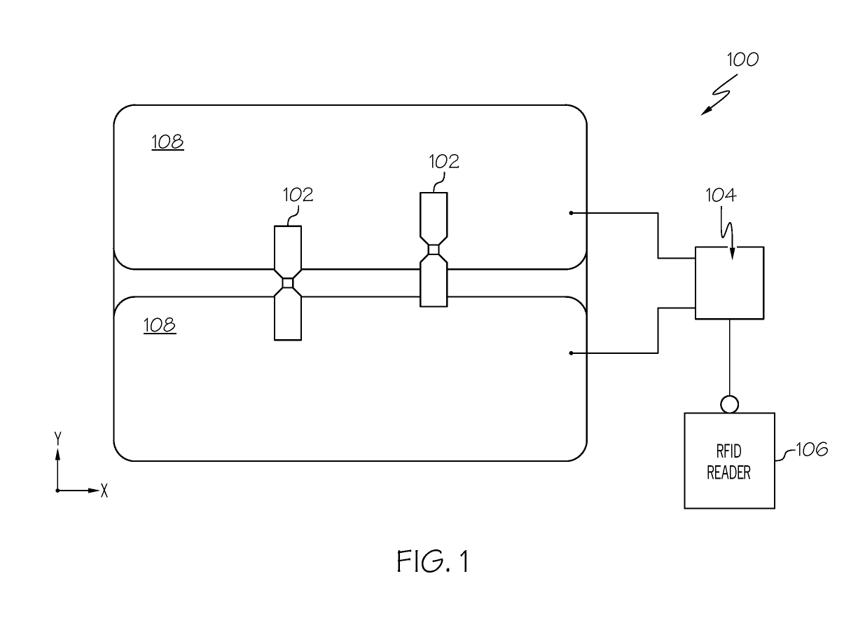

Turning now to exemplary FIG. 1, FIG. 1 displays an exemplary embodiment of a pairing 100 between an RFID strap 102 and a coupler 104. In the exemplary embodiment of FIG. 1, a coupler 104 may include one or more sets of a metallic structure that has at one or more points creating a differential electric field such as coupler plates 108, which may be connected to an RFID reader 106. In an exemplary embodiment, the coupler plates 108 may be disposed near one another (they may, for example, run parallel or substantially parallel to one another) and may be separated by a gap disposed between them. While the present invention speaks to the utilization of coupler plates 108, it is not limited to such and contemplates the utilization of any metallic structure known in the art, such as a bridge, to create a differential electric field.

According to one embodiment, a differential electric field may be provided between the coupler plates 108 of the coupler 104. Such a differential electric field may be provided by, for example, the RFID reader 106, or by another component, as desired. Such a differential electric field may act to operate the RFID strap 102 when the RFID strap 102 is brought into close connection with the coupler plates 108 of the coupler 104.

According to an exemplary embodiment, an X direction and a Y direction may be established, such that, for example, the X direction runs horizontally and the Y direction runs vertically, as shown in FIG. 1. In the exemplary embodiment shown in FIG. 1, the X direction may be parallel to the length of the gap between the coupler plates 108, and the Y direction may be perpendicular to this direction.

According to an exemplary embodiment, a user may operate a coupler 104 by placing an RFID strap 102, which may be located on some other article configured to carry the RFID strap 102, over the coupler plates 108, such that the RFID strap 102 bridges the coupler plates 108. In an exemplary embodiment, a user may place the RFID strap 102, located on the carrier article, over the coupler 104, such that there is minimal variation of the RFID strap 102 in the Y direction. A user may then move the article in the X direction in order to move the RFID strap 102 in the X direction, over the coupler plates 108. In an exemplary embodiment, once the RFID strap 102 is placed so that it is in an appropriate Y location on the coupler plates 108, it may be read.

According to an exemplary embodiment, there may be a significant amount of tolerance in the positioning of the RFID strap 102 to the coupler 104. In an embodiment, there may be a significant amount of tolerance in each of the X, the Y, and the Z directions; in other exemplary embodiments, there may be less tolerance in any of the directions or in any combination of directions. This may ensure that, for example, the RFID strap 102 may be located at a point having at least some Y offset and can still be read. The positional tolerance is related to the size of the strap pads and the pads and the structures the strap(s) couples to. In one example, the strap pads may be smaller than the plates they are coupling to; for example, the strap pads may be 2 mm×2 mm. In one embodiment, coupler pads may be 3 mm×3 mm in size. In this instance, a +/−0.5 mm movement of the strap in relation to the coupler pad (s) will not change the overlap area between the strap and coupler pad maintain a constant coupling.

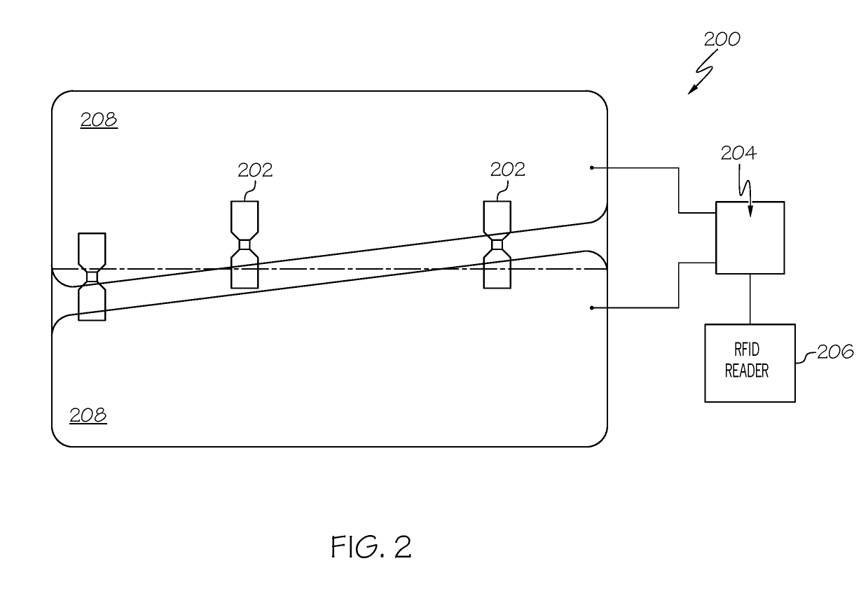

Turning now to exemplary FIG. 2, FIG. 2 displays an alternative exemplary embodiment of a pairing 200 between an RFID strap 202 and a coupler 204, which may include one or more sets of coupler plates 208 connected to an RFID reader 206. In an exemplary embodiment, the coupler plates 208 may be disposed near one another (they may, for example, run parallel or substantially parallel to one another) and may be separated by a gap disposed between them.

According to an exemplary embodiment, rather than being disposed parallel to the X direction, the gap provided between the coupler plates 208 may be disposed at an angle such that the gap varies with the X direction. In an embodiment, this may ensure that, when RFID straps 202 are introduced in the X direction and are misplaced in the Y direction, the RFID straps 202 will go over an area that has a differential field coupling to each of the two sides of the strap 202.

For example, a coupler 204 having a pair of coupler plates 208 may also be provided with two points, B and C, shown in FIG. 2. According to an exemplary embodiment, an RFID strap 202 may be introduced having a certain position along the Y axis. At B, the position of the RFID strap 202 along the Y axis may have too large an offset to be successfully read, and as such the RFID strap 202 may not be read at point B. However, at point C, the position of the RFID strap 202 along the Y axis may coincide with the position of the gap between the coupler plates 208, and as such the RFID strap 202 may be readable.

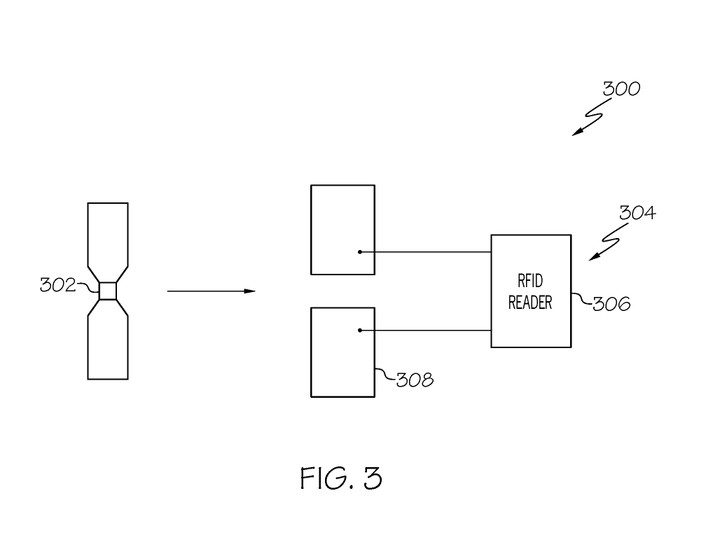

Turning now to exemplary FIG. 3, FIG. 3 displays an exemplary diagram illustrating the process of coupling by capacitance 300 using an RFID strap 302 and an RFID coupler 304.

To provide appropriate background, in general, RFID capacitive coupling may be used for short ranges wherein close RFID coupling (i.e. around 1 cm) is needed. Such a system may make use of capacitive effects to provide coupling between the RFID tag and the RFID reader. This system can be used for, for example, smart cards under ISO 10536.

Essentially, in capacitive coupling, an RFID tag may make use of electrodes (specifically the plates of a capacitor) rather than an antenna or a coil in order to provide the required coupling between the RFID tag and the RFID reader. In capacitive coupling, an RFID tag may be placed in close proximity to an RFID reader. The capacitance between the RFID tag and the RFID reader may provide a capacitor through which a signal can be transmitted; in some exemplary embodiments, this may further require an earth return. Once this capacitor has been established, an AC signal may be transmitted through it by the reader, and the AC signal generated by the reader may be picked up and rectified within the RFID tag and used to power the devices within the tag. The data may then be returned to the RFID reader by modulation of the load.

As such, according to the exemplary embodiment shown in FIG. 3, an RFID strap 302—a very small differential electric field device—may be brought into proximity with the coupling plates 308 of a coupler 304, which may further have an RFID reader 306. According to an exemplary embodiment, the RFID strap 302 may then be read by the RFID reader 306.

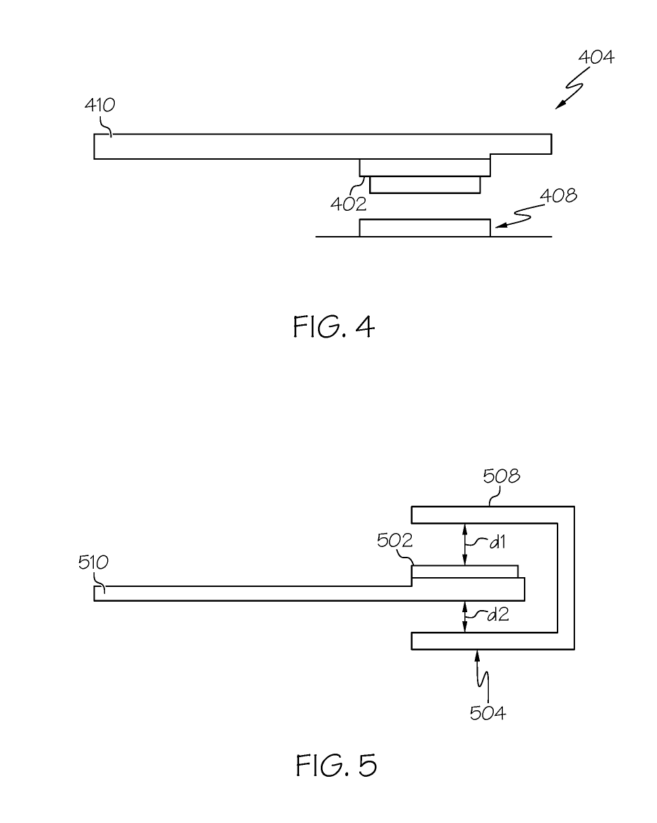

Turning now to exemplary FIG. 4, FIG. 4 shows an exemplary embodiment of a side view of a coupler 404. According to an exemplary embodiment, a coupler 404 may have a plurality of coupler plates 408, which may all point along the same axis; for example, according to an exemplary embodiment, a coupler 404 may have two coupler plates 408 facing up, facing down, or facing sideways.

According to an exemplary embodiment, a user may insert a carrier plate 410 upon which may be disposed an RFID strap 402. The RFID strap 402 may be positioned over the coupler plate 408 such that it is spaced a distance “d” apart from the coupler plate 408. In an embodiment, the capacitance and coupling of the coupler-strap pairing may be reduced as d is increased, meaning that, in some exemplary embodiments, the RFID strap 402 may have to be directly placed on top of the coupler plate 408 in order to be read.

Turning now to exemplary FIG. 5, FIG. 5 shows an exemplary embodiment of a side view of a coupler 504. According to an alternative exemplary embodiment, instead of a coupler 404 having coupler plates 408 disposed on only one surface, a coupler 504 may instead have a coupling aperture 508. In such an embodiment, the RFID strap 502, on its carrier 510, may be placed within the arms of a C-shaped structure 508. This may ensure that the RFID strap 502 is connected to the coupler 504 by two different capacitors (one on top and one below), rather than just one. An RFID strap 502 may be separated from the top or first portion of the coupling aperture 508 by a distance “d1” and may be separated from the bottom or second portion of the coupling aperture 508 by a distance “d2”. As “d1” increases, “d2” may be decreased, and vice-versa. This may ensure that the total capacitance of the coupling that is associated with “d1” and “d2” is substantially constant.

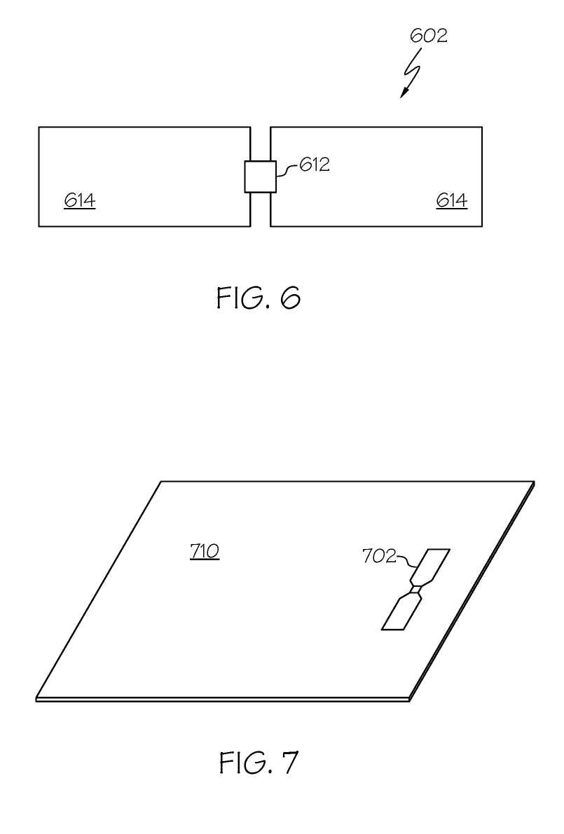

Turning now to exemplary FIG. 6, FIG. 6 shows an exemplary embodiment of an RFID strap 602. According to an exemplary embodiment, an RFID strap 602 may include a chip 612 and a plurality of attachment pads 614. According to an exemplary embodiment, a chip 612 may be centrally located between the attachment pads 614, each of which may be the same size; according to another exemplary embodiment, a chip 612 may be located elsewhere.

According to some exemplary embodiments, an RFID strap 602 may be printed on the substrate, such as paper, PE or PET substrate, which may surround the attachment pads 614. In another exemplary embodiment, attachment pads 614 may be free-standing components, as desired.

According to an exemplary embodiment, an RFID strap 602 may, when fully assembled, extend approximately 10 mm in the X direction and approximately 5 mm in the Y direction, as shown in FIG. 6. According to another exemplary embodiment, an RFID strap 602 may be a different size. According to an exemplary embodiment, the attachment pads 614 may be a small fraction of the size of a wavelength of a radio wave used at the operating frequency.

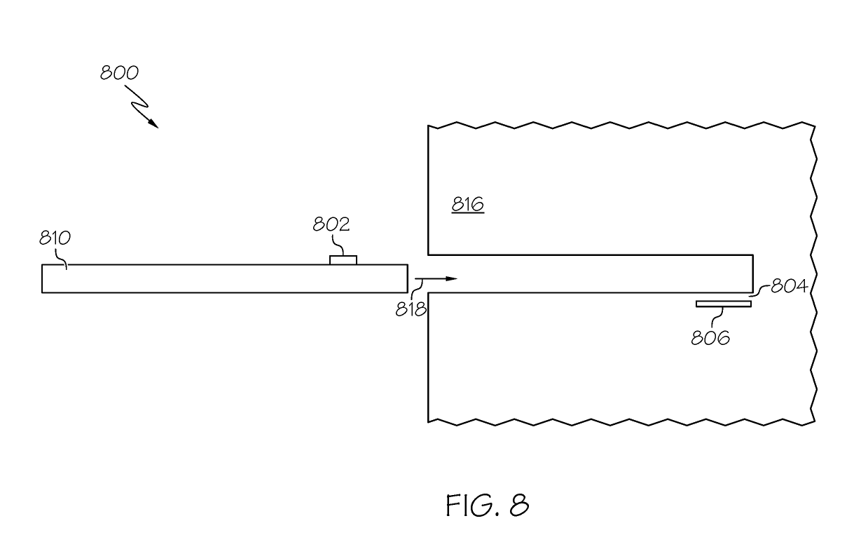

Turning now to exemplary FIG. 7, FIG. 7 displays an exemplary embodiment of an article 710 configured to carry an RFID strap 702. For example, according to an exemplary embodiment, an article 710 may be a payment card or a ticket to an event. In an exemplary embodiment, an RFID strap 702 may be centrally disposed on one end of the article 710; in another exemplary embodiment, RFID straps 702 may be disposed elsewhere on the article 710, or on multiple locations on the article 710.

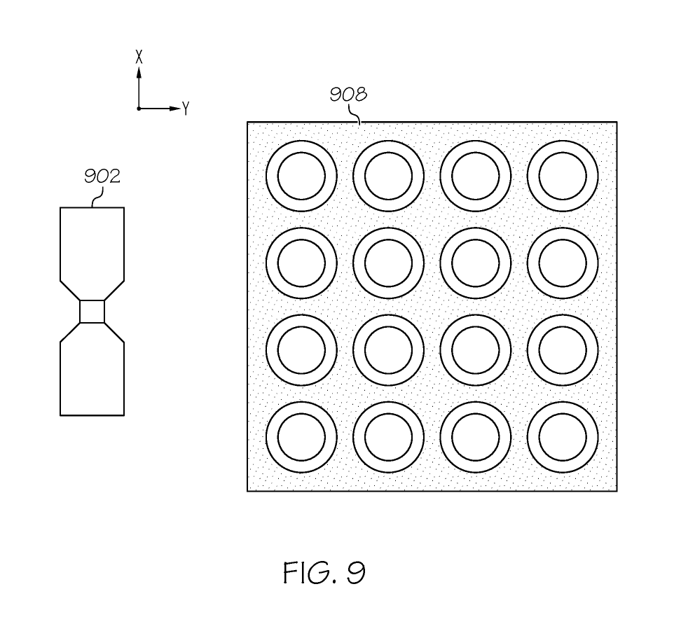

Turning now to exemplary FIG. 8, FIG. 8 displays an exemplary diagram demonstrating the use of an article 810 configured to carry an RFID strap 802. In order to scan the article 810, the user may insert the article 810 into a ticket or vending system 816 having a slot or aperture 818, in which a coupler 804 may be disposed. The article 810 may then be coupled to the coupler 804, and may be read by an RFID reader 806.

Turning now to FIG. 9, FIG. 9 displays an exemplary diagram illustrating the use of an RFID device 902 with a surface 908, specifically a coupling plate 908, which may provide coupling regardless of relative, X, Y and theta orientation. According to an exemplary embodiment, a surface 908 may provide a differential field for all values of X, Y, and theta, ensuring that, regardless of what the values are for X, Y, and theta, the RFID device 902 can be coupled.

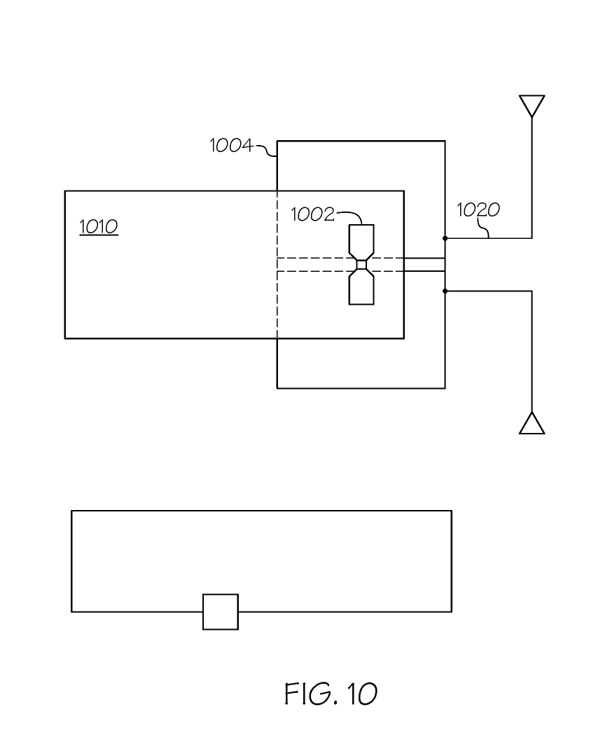

Turning now to exemplary FIG. 10, FIG. 10 displays an exemplary embodiment of an RFID device 1002 coupled to a far-field antenna 1020. According to an exemplary embodiment, it may be desired to locate an RFID reader at a location remote from the coupler 1004. According to such an exemplary embodiment, a far-field antenna 1020 may instead be connected to a coupler 1004. When an article 1010 featuring an RFID device 1002 is inserted into an appropriate location and coupled to the coupler 1004, the RFID reader at the remote location may communicate, through the far-field antenna 1020, with the RFID device 1002. This may allow for greater flexibility on the placement of reader structures inside machines or ticket reading stations.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A RFID pairing system comprising:
at least one strap and at least one coupler;
at least one pair of coupler plates;
and a differential electric field exists between the at least one pair of coupler plates and the at least one coupler.

2. The system of claim 1, wherein the differential electric field is provided by a RFID reader.

3. The system of claim 1, wherein the differential electric field operates the at least one strap when the at least one strap is brought into connection with the at least one pair of coupler plates and the at least one coupler.

4. The system of claim 1, wherein at least one gap separates the at least one pair of coupler plates.

5. The system of claim 4, wherein an X direction and Y direction is established such that the X direction is parallel to a length of the at least one gap between the at least one pair of coupler plates and the Y direction is perpendicular to this direction.

6. The system of claim 1, wherein the at least one gap is at an angle such that the gap varies with an X direction.

7. A method of operating a differential electric field activated RFID device comprising the steps of:
providing at least one RFID device;
providing a strap, a coupler, at least one set of coupler plates;
placing the strap over the at least one set of coupler plates such that the RFID strap bridges the at least one set of coupler plates; and
reading the RFID device.

8. The method of claim 7, wherein the method further comprises providing an article with the at least one device and after placing the strap over the at least one set of coupler plates, moving the RFID strap in an X direction over the at least one set of coupler plates.

9. The method of claim 7, wherein the at least one pair of coupler plates is provided with at least one point and the RFID strap has a certain position along an axis.

10. The method of claim 9, wherein the strap is positioned along the axis at the at least one point.

11. The method of claim 10, wherein the method further comprises providing a reader such that the at least one RFID device is capacitively coupled to the RFID reader.

12. The method of claim 7, wherein the at least one set of coupler plates all point along a same axis.

13. The method of claim 7, wherein the strap is disposed on a carrier plate.

14. A RFID pairing system comprising:
at least one strap and at least one coupler;
at least one metallic structure;
and a differential electric field exists between the at least one metallic structure and the at least one coupler.
